(19) United States
(12) Patent Application Publication
(10) Pub. No.: US 2025/0013505 A1
(43) Pub. Date: Jan. 9, 2025

(54) COMPUTER-READABLE RECORDING MEDIUM STORING INFORMATION PROCESSING PROGRAM, COMPUTER SYSTEM, AND INFORMATION PROCESSING METHOD

(71) Applicant: Fujitsu Limited, Kawasaki-shi (JP)

(72) Inventor: Shinya KUWAMURA, Kawasaki (JP)

(73) Assignee: Fujitsu Limited, Kawasaki-shi (JP)

(21) Appl. No.: 18/739,938

(22) Filed: Jun. 11, 2024

(30) Foreign Application Priority Data
Jul. 4, 2023 (JP) 2023-109927

(51) Int. Cl. G06F 9/50

(52) U.S. Cl. CPC G06F 9/5077; G06F 2209/503

(57) ABSTRACT

A computer-readable recording medium stores an information processing program for a processor in an information processing apparatus to which a first physical resource among a plurality of physical resources of a resource pool is dynamically added, within a computer system having a composable infrastructure that includes the resource pool that includes the plurality of physical resources. The program causes the processor to execute a process including: initializing the first physical resource when the first physical resource is added; issuing a calculation command to the first physical resource after initialization based on an arithmetic processing instruction issued from an application function that is realized by executing an application program by the processor; and transmitting a result of arithmetic operation by the first physical resource to the application function.

### CROSS-REFERENCE TO RELATED APPLICATION

This application is based upon and claims the benefit of priority of the prior Japanese Patent Application No. 2023-109927, filed on Jul. 4, 2023, the entire contents of which are incorporated herein by reference.

### FIELD

The embodiment discussed herein is related to a computer-readable recording medium storing an information processing program, a computer system, and an information processing method.

### BACKGROUND

In recent years, a composable infrastructure (CI) has been known as a configuration of a computer system. A composable infrastructure is an infrastructure configured by an architecture in which resources such as a memory, a graphics processing unit (GPU), and a solid-state drive (SSD) are separated from a server and construct resource pools, and the resource pools are coupled to the server through a high-speed interconnect.

For example, Peripheral Component Interconnect-Express (PCIe), Ethernet (registered trademark), and InfiniBand (registered trademark) are used as the interconnect.

A resource may be a field-programmable gate array (FPGA) or an accelerator, in addition to the memory, GPU, and SSD described above. A resource that is a processor used for arithmetic processing in particular such as a GPU, an FPGA, or an accelerator may be referred to as a calculation resource.

In a composable infrastructure, by adding a resource to a server as appropriate, a physical server of a flexible configuration may be provided and the use efficiency of resources may be improved.

There are cases in which the infrastructure is referred to as a composable disaggregated infrastructure (CDI) instead of a composable infrastructure.

For example, in order for an application executed on a server to cause a calculation resource to perform arithmetic processing in such composable infrastructure of related art, processing of the following procedure is performed at the time of device activation.
1. Initialization of calculation resource
2. Memory allocation and data transfer to calculation resource
3. Issuance of calculation processing to calculation resource

After that, memory allocation, data transfer, and issuance of calculation processing are repeatedly performed as appropriate.

Japanese National Publication of International Patent Application No. 2020-537197, Japanese Laid-open Patent Publication No. 2009-181578, U.S. Patent Application Publication No. 2014/0181806, and U.S. Patent Application Publication No. 2014/0181807 are disclosed as related art.

### SUMMARY

According to an aspect of the embodiments, a computer-readable recording medium stores an information processing program for causing a processor, in an information processing apparatus to which a first physical resource among a plurality of physical resources of a resource pool is dynamically added, within a computer system having a composable infrastructure that includes the resource pool that includes the plurality of physical resources, to execute a process including: initializing the first physical resource when the first physical resource is added; issuing a calculation command to the first physical resource after initialization based on an arithmetic processing instruction issued from an application function that is realized by executing an application program by the processor; and transmitting a result of arithmetic operation by the first physical resource to the application function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of a computer system as an example of an embodiment;

FIG. 2 is a diagram exemplifying a hardware configuration of a server in the computer system according to the embodiment;

FIG. 3 is a diagram exemplifying a system configuration of the server of the computer system according to the embodiment;

FIG. 4 is a diagram illustrating an overview of processing of a relay module in the computer system according to the embodiment;

FIG. 5 is a diagram exemplifying a functional configuration of the relay module in the computer system according to the embodiment;

FIG. 6 is a diagram exemplifying resource management information in the computer system according to the embodiment;

FIG. 7 is a sequence diagram illustrating an overview of processing in the computer system according to the embodiment;

FIG. 8 is a sequence diagram illustrating processing at the time of resource addition in the computer system according to the embodiment;

FIG. 9 is a flowchart for describing processing of the relay module at the time of command reception in the computer system according to the embodiment; and

FIG. 10 is a diagram illustrating another example of a system configuration of the server of the computer system according to the embodiment.

### DESCRIPTION OF EMBODIMENTS

In the known composable infrastructure, dynamic addition of a resource is supported in terms of hardware and operating system (OS), but dynamic addition of a resource is not supported in terms of application.

For example, an application is created on the assumption that a configuration of resources is unchanged after initialization immediately after activation by defining the number and types of resources with constants or the like. Therefore, the application may not perform initialization or the like for a resource that is dynamically added.

For an application to support addition of a resource, a large-scale change such as a change in a program code of the application has to be made, which leads to high cost.

In one aspect, an object of the present disclosure is to enable addition and deletion of physical resources to be dynamically executed.

Hereinafter, an embodiment of an information processing program, a computer system, and an information processing method will be described with reference to the drawings. However, the embodiment described below is merely an example, and is not intended to exclude the application of various modification examples and techniques that are not explicitly described in the embodiment. For example, the present embodiment may be variously modified and implemented within a scope not departing from the gist thereof. Each drawing is not intended to indicate that only constituent elements illustrated in the drawings are included, and other functions or the like may be included.

### (A) Configuration

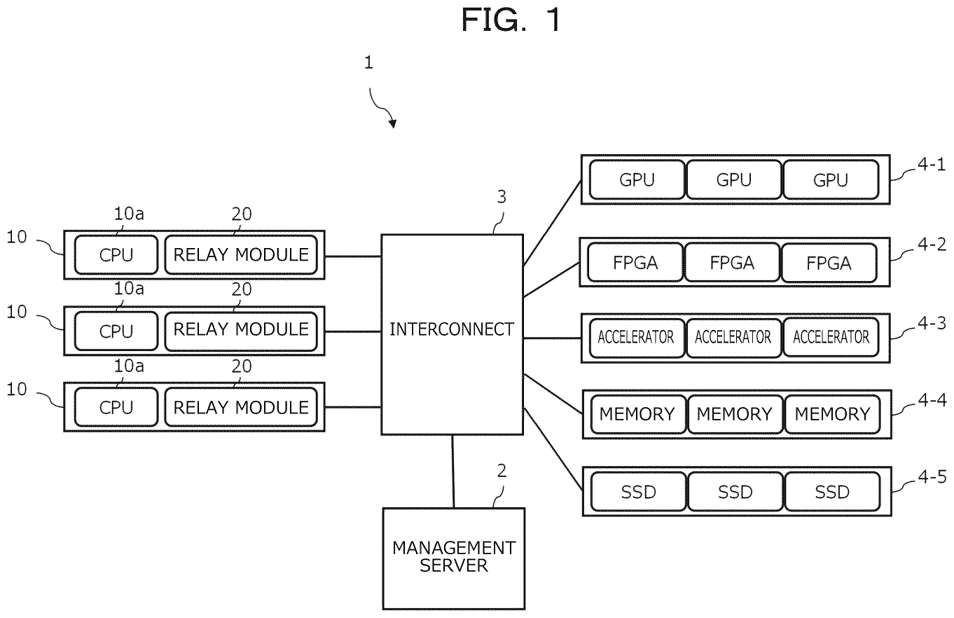

FIG. 1 is a diagram schematically illustrating a configuration of a computer system 1 as an example of the embodiment.

The computer system 1 exemplified in FIG. 1 includes a management server 2, an interconnect 3, resource pools 4-1 to 4-5, and one or more (three in the example illustrated in FIG. 1) servers 10.

Each server 10, the management server 2, and the resource pools 4-1 to 4-5 are coupled to each other via the interconnect 3.

The interconnect 3 is a high-speed communication line. For example, the interconnect may be PCIe, Ethernet, or InfiniBand.

A switch function may be included in the interconnect 3. The management server 2 to be described later controls switching of the switch, thereby achieving coupling (addition) of a resource to the server 10 and decoupling (deletion) of a resource from the server 10.

The computer system 1 has a composable infrastructure configured to be capable of dynamically adding a resource (calculation resource) to the server 10.

Each of the resource pools 4-1 to 4-5 includes a plurality of resources. Hereinafter, there are cases in which each resource included in each resource pool 4 is referred to as a physical resource.

In the example illustrated in FIG. 1, the resource pool 4-1 includes a plurality of GPUs. A GPU included in the resource pool 4-1 may be referred to as a physical GPU. The resource pool 4-2 includes a plurality of FPGAs. An FPGA included in the resource pool 4-2 may be referred to as a physical FPGA. The resource pool 4-3 includes a plurality of accelerators. An accelerator included in the resource pool 4-3 may be referred to as a physical accelerator.

A GPU, an FPGA, and an accelerator included as resources in the resource pools 4-1 to 4-3 are processors capable of executing arithmetic processing. These processors may be referred to as calculation resources. Physical resources that are calculation resources may be referred to as physical calculation resources.

The resource pool 4-4 includes a plurality of memories. The resource pool 4-5 includes a plurality of SSDs. A memory included in the resource pool 4-4 and an SSD included in the resource pool 4-5 are both non-calculation resources.

Hereinafter, in a case where the resource pools 4-1 to 4-5 are not particularly distinguished, the resource pools are referred to as the resource pool 4.

The management server 2 performs control of coupling a resource in each resource pool 4 to each server 10 and control of decoupling a resource coupled to each server 10 from the server 10. These functions of the management server 2 are known, and description thereof will be omitted.

The management server 2 controls switching of the switch included in the interconnect 3, thereby achieving coupling (addition) of a resource to the server 10 and decoupling (deletion) of a resource from the server 10.

Hereinafter, coupling of a resource to the server 10 may be referred to as resource addition. Decoupling of a resource from the server 10 may be referred to as resource deletion.

The server 10 is an information processing device having a server function. Resources are allocated from each resource pool 4 to each server 10 by the management server 2. For example, a GPU, an FPGA, an accelerator, a memory, and an SSD are allocated to the server 10 from the resource pools 4-1, 4-2, 4-3, 4-4, and 4-5, respectively.

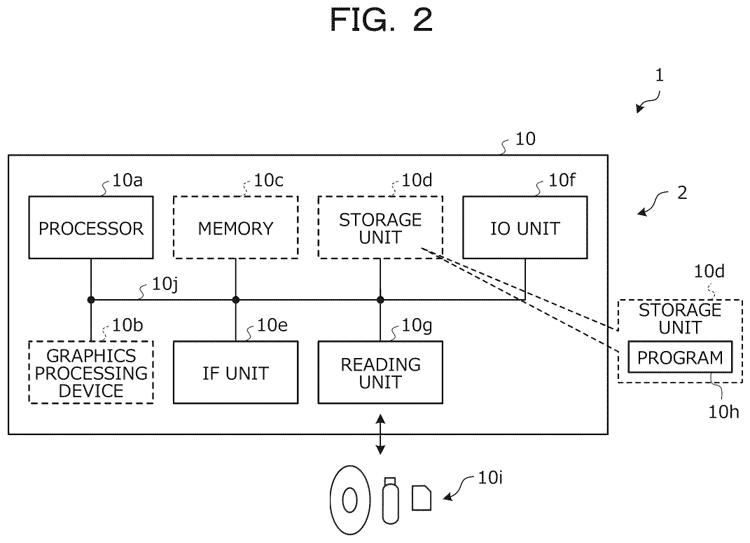

FIG. 2 is a diagram exemplifying a hardware configuration of the server 10 in the computer system 1 according to the embodiment.

As illustrated in FIG. 2, as an example of a hardware configuration, the server 10 may include a processor 10a, a graphics processing device 10b, a memory 10c, a storage unit 10d, an interface (IF) unit 10e, an input/output (IO) unit 10f, and a reading unit 10g.

The graphics processing device 10b may be a GPU allocated from the resource pool 4-1. The memory 10c may be a memory allocated from the resource pool 4-4. The storage unit 10d may be an SSD allocated from the resource pool 4-5.

The processor 10a is an example of an arithmetic processing device that performs various controls and arithmetic operations, and is a control unit that executes various kinds of processing. The processor 10a may be coupled to each block in the server 10 via a bus 10j so as to communicate with each other. The processor 10a may be a multiprocessor including a plurality of processors or a multi-core processor including a plurality of processor cores, or may have a configuration including a plurality of multi-core processors.

Examples of the processor 10a include integrated circuits (ICs) such as a CPU, an MPU, an APU, a DSP, an ASIC, and an FPGA. A combination of two or more of these integrated circuits may be used as the processor 10a. CPU is an abbreviation for central processing unit, and MPU is an abbreviation for microprocessor unit. APU is an abbreviation for accelerated processing unit. DSP is an abbreviation for digital signal processor, and ASIC is an abbreviation for application specific IC.

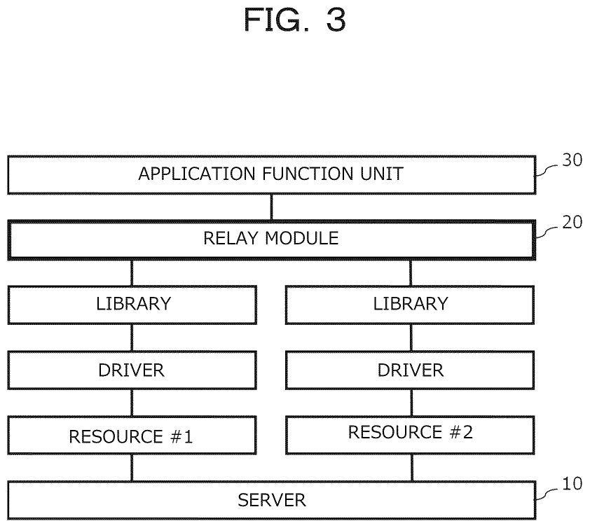

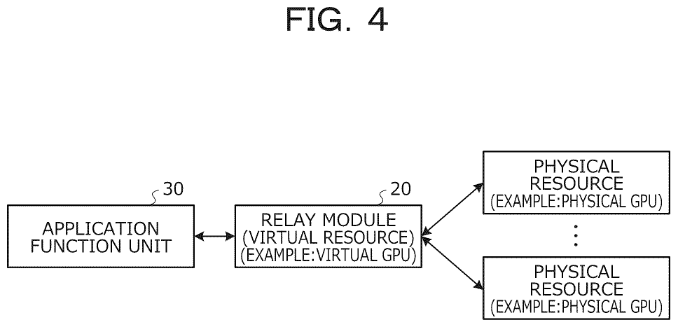

By the processor 10a executing an information processing program, the function as a relay module 20 to be described later (see FIGS. 3 to 5 and the like) is realized. By the processor 10a executing an application program, the function as an application function unit 30 to be described later (see FIGS. 3, 4, and the like) is realized.

The graphics processing device 10b performs screen display control for an output device such as a monitor included in the IO unit 10f. The graphics processing device 10b may have a configuration as an accelerator that executes machine learning processing and inference processing using a machine learning model. Examples of the graphics processing device 10b include various arithmetic processing devices, for example, ICs such as a GPU, an APU, a DSP, an ASIC, and an FPGA.

The memory 10c is an example of hardware (HW) that stores information such as various types of data and programs. Examples of the memory 10c include one or both of a volatile memory such as a dynamic random-access memory (DRAM) and a nonvolatile memory such as a persistent memory (PM).

The storage unit 10d is an example of HW that stores information such as various types of data and programs. Examples of the storage unit 10d include a magnetic disk device such as a hard disk drive (HDD), a semiconductor drive device such as an SSD, and various storage devices such as a nonvolatile memory. Examples of the nonvolatile memory include a flash memory, a storage class memory (SCM), a read-only memory (ROM), and the like.

The storage unit 10d may store a program 10h for realizing all or part of various functions of the server 10.

The processor 10a realizes various functions by loading the program 10h to the memory 10c and executing the program. The program executed by the processor 10a includes an information processing program for realizing the function as the relay module 20 to be described later and an application program for realizing the function as the application function unit 30 to be described later.

The IF unit 10e is an example of a communication IF that performs control or the like for coupling and communication between the server 10 and another electronic device or another computer. For example, the IF unit 10e may be a PCIe interface adapter, a network interface adapter, or the like for coupling to the interconnect 3. The adapter may support one or both of a wireless communication method and a wired communication method.

The server 10 may be coupled to each resource pool 4 and the management server 2 illustrated in FIG. 1 so as to communicate with each other via the IF unit 10e and the interconnect 3. The program 10h may be downloaded from a network to the server 10 via the communication IF and stored in the storage unit 10d.

The IO unit 10f may include one or both of an input device and an output device. Examples of the input device include a keyboard, a mouse, a touch panel, and the like. Examples of the output device include a monitor, a projector, a printer, and the like. The IO unit 10f may include a touch panel or the like in which an input device and an output device are integrated. The output device may be coupled to the graphics processing device 10b.

The reading unit 10g is an example of a reader that reads information on programs and data recorded in a recording medium 10i. The reading unit 10g may include a coupling terminal or a device to which the recording medium 10i may be coupled or inserted. Examples of the reading unit 10g include an adapter that conforms to Universal Serial Bus (USB) or the like, a drive device that accesses a recording disk, a card reader that accesses a flash memory such as a secure digital (SD) card, and the like. The program 10h may be stored in the recording medium 10i, and the reading unit 10g may read the program 10h from the recording medium 10i and store the program 10h in the storage unit 10d.

Examples of the recording medium 10i include a non-transitory computer-readable recording medium such as a magnetic/optical disk or a flash memory. Examples of the magnetic/optical disk include a flexible disk, a compact disc (CD), a Digital Versatile Disc (DVD), a Blu-ray disc, a holographic versatile disc (HVD), and the like. Examples of the flash memory include a semiconductor memory such as a USB memory or an SD card.

The hardware configuration of the server 10 described above is an exemplification. Therefore, an increase or decrease in hardware (for example, addition or deletion of arbitrary block), division, integration in arbitrary combination, or addition, deletion, or the like of a bus may be performed in the server 10 as appropriate.

As described above, in the server 10, by the processor 10a executing an application program, the function as the application function unit 30 is realized, and by the processor 10a executing an information processing program, the function as the relay module 20 is realized.

FIG. 3 is a diagram exemplifying a system configuration of the server 10 of the computer system 1 according to the embodiment.

In the example illustrated in FIG. 3, resource #1 and resource #2 are added to the server 10. These resources #1 and #2 are different types of calculation resources. For example, resource #1 may be a GPU, and resource #2 may be an FPGA.

A driver is provided for each of these resources #1 and #2, and a library is provided for each driver.

The relay module 20 is provided between each library and the application function unit 30.

For example, the application function unit 30 causes a calculation resource to perform an arithmetic operation. The application function unit 30 performs transmission of a calculation command and transmission (transfer) of data to be used for calculation to a calculation resource via the relay module 20.

As will be described later, the application function unit 30 recognizes the relay module 20 as a virtual calculation resource. Accordingly, transmission of a command or the like to a calculation resource by the application function unit 30 is actually performed to the relay module 20.

Immediately after the application function unit 30 itself is activated, the application function unit 30 issues an initialization command to a calculation resource to be added to the own server 10. Processing of detecting the number of usable resources is included in the initialization processing by an application.

The application function unit 30 issues, to the calculation resource to be added to the own server 10, a memory allocation command that instructs memory allocation.

Each command issued from the application function unit 30 in this manner to be transmitted to the calculation resource is actually input to the relay module 20.

In the server 10, the relay module 20 relays exchange of commands and data between the application function unit 30 that functions in the server 10 and a calculation resource (physical resource). Hereinafter, in a case of being simply referred to as a resource, the resource represents a calculation resource.

FIG. 4 is a diagram illustrating an overview of processing of the relay module 20 in the computer system 1 according to the embodiment.

The relay module 20 causes the application function unit 30 to recognize a virtual resource (virtual calculation resource). For example, the relay module 20 causes a virtual calculation resource to be recognized by responding with 1 (number of virtual resources) when the number of usable resources is detected in the initialization processing by an application. In the subsequent processing for a resource, the relay module 20 transfers a command to a corresponding physical resource according to the type of the command.

The relay module 20 receives all commands issued from the application function unit 30 to a resource, and performs processing for the resource based on these commands. The relay module 20 receives a response (a calculation result, a completion notification, or the like) to the application function unit 30 transmitted from the resource, and transfers the response to the application function unit 30.

It may be said that the relay module 20 causes the application function unit 30 to recognize a virtual calculation resource instead of a physical calculation resource.

In a case where a calculation command is issued from the application function unit 30 to a physical resource in a state where a plurality of physical resources is added to the server 10, the relay module 20 selects one physical resource from among the plurality of physical resources and transfers the calculation command. For example, the relay module 20 appropriately allocates a calculation command issued from an application to one or more calculation resources.

Even in a case of being in a state where a plurality of calculation resources is added to the server 10 by the management server 2 dynamically adding a resource (calculation resource) to the server 10, the relay module 20 causes the application function unit 30 of the server 10 to recognize one calculation resource (virtual resource).

When a calculation resource is added to the server 10, the relay module 20 performs processing of initializing the resource to be added (added resource).

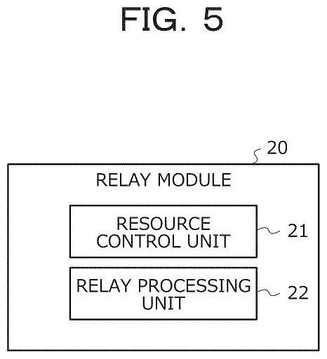

FIG. 5 is a diagram exemplifying a functional configuration of the relay module 20 in the computer system 1 according to the embodiment.

As illustrated in FIG. 5, as an example, the relay module 20 may have the functions as a resource control unit 21 and a relay processing unit 22. These functions may be realized by the hardware components of the server 10 (see FIG. 2).

The resource control unit 21 performs control or the like for making a state in which the application function unit 30 may use a resource (calculation resource).

When a resource (added resource) is added to the own server 10, the resource control unit 21 performs initialization for the added resource. For example, the resource control unit 21 performs the processing of initializing the added resource by transmitting an initialization command to the added resource.

The initialization command issued by the resource control unit 21 (relay module 20) may be similar to an initialization command issued by the application function unit 30. However, processing of detecting the number of usable resources does not have to be included in the initialization processing of a resource by the resource control unit 21.

For example, addition of a calculation resource may be performed in a case where a monitoring function (not illustrated) monitors a load state of a calculation resource in execution of an arithmetic operation, and the load state exceeds a threshold. For example, the load state may be a usage rate of a calculation resource (GPU, FPGA, or accelerator). Addition of a calculation resource may also be performed in a case where a user determines addition of a calculation resource and an input operation indicating that a calculation resource is to be added is performed.

The added resource that has received the initialization command executes processing for initialization defined in advance. For example, the processing for initialization may include preparation for enabling exchange of data such as a command to be performed between the added resource and the server 10. For example, in the initialization processing, the added resource reserves, in the memory 10c of the server 10, a storage area to be used for exchanging data such as a command with the added resource.

When resource addition is performed, the resource control unit 21 performs memory allocation to the added resource. For example, the resource control unit 21 transmits a memory allocation command to the added resource. The memory allocation command issued by the resource control unit 21 (relay module 20) may be similar to a memory allocation command issued by the application function unit 30.

The added resource that has received the memory allocation command executes processing for memory allocation defined in advance. For example, the processing for memory allocation may include processing of reserving a storage area to be used for exchange of data with the server 10 in a memory (not illustrated) included in the added resource.

The resource control unit 21 manages a resource that is added to the own server 10 and is in a usable state, by using resource management information.

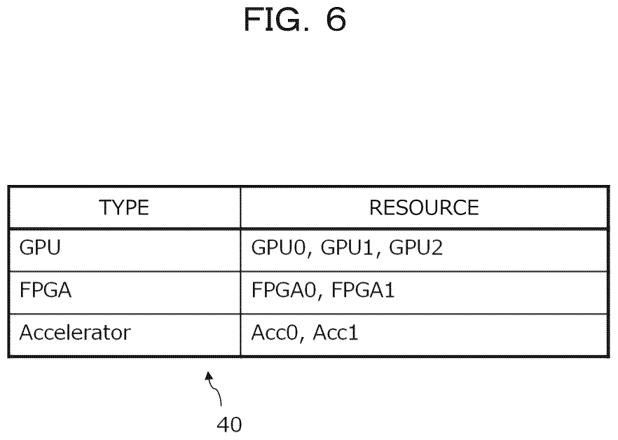

FIG. 6 is a diagram exemplifying resource management information in the computer system 1 according to the embodiment.

FIG. 6 illustrates resource management information with reference sign 40. Hereinafter, there are cases in which resource management information is referred to as resource management information 40.

The resource management information 40 exemplified in FIG. 6 is configured by associating type and resource with each other. Type is a type of a resource. In the example illustrated in FIG. 6, GPU, FPGA, and accelerator are exemplified. Resource is information for identifying a resource. In the example illustrated in FIG. 6, for example, GPU0, GPU1, and GPU2 are illustrated as GPU.

The resource control unit 21 records, in the resource management information 40, information on an added resource that has become usable from the own server 10 by issuing an initialization command and a memory allocation command. The resource control unit 21 deletes, from the resource management information 40, information on a resource decoupled from the own server 10. In this way, the resource control unit 21 manages and updates the resource management information 40.

For example, the resource management information 40 is stored in a predetermined storage area of the memory 10c or the storage unit 10d used by the own server 10.

In a case where a calculation command is issued from the application function unit 30 in a state where a plurality of resources is added to the server 10, the resource control unit 21 selects a resource for processing the calculation command. Hereinafter, a resource selected for processing a calculation command may be referred to as a selected resource.

For example, in a case where a calculation command is issued from the application function unit 30 in a state where a plurality of GPUs is added to the server 10, the resource control unit 21 selects a GPU (selected resource) for processing the calculation command from among the plurality of GPUs coupled to the server 10.

The resource control unit 21 may select a selected resource such that loads are uniform among a plurality of physical resources of the same type.

For example, the resource control unit 21 may select a selected resource by a round-robin method among a plurality of physical resources of the same type, or may preferentially select a resource having the lowest usage rate as a selected resource. The resource control unit 21 may randomly select a selected resource from among a plurality of physical resources of the same type.

The relay processing unit 22 relays data between the application function unit 30 and a resource.

The relay processing unit 22 receives a command transmitted from the application function unit 30 to a resource, and transmits (transfers) the command to the transmission destination resource. For example, the relay processing unit 22 receives an initialization command and a memory allocation command transmitted from the application function unit 30 to a resource, and transmits the initialization command and the memory allocation command to the transmission destination resource.

The relay processing unit 22 receives data or the like transmitted from a resource to the application function unit 30, and transmits (transfers) the data to the application function unit 30. For example, the relay processing unit 22 receives data of a calculation result and a completion notification transmitted from a resource to the application function unit 30, and transmits (transfers) the data and the completion notification to the application function unit 30.

### (B) Operation

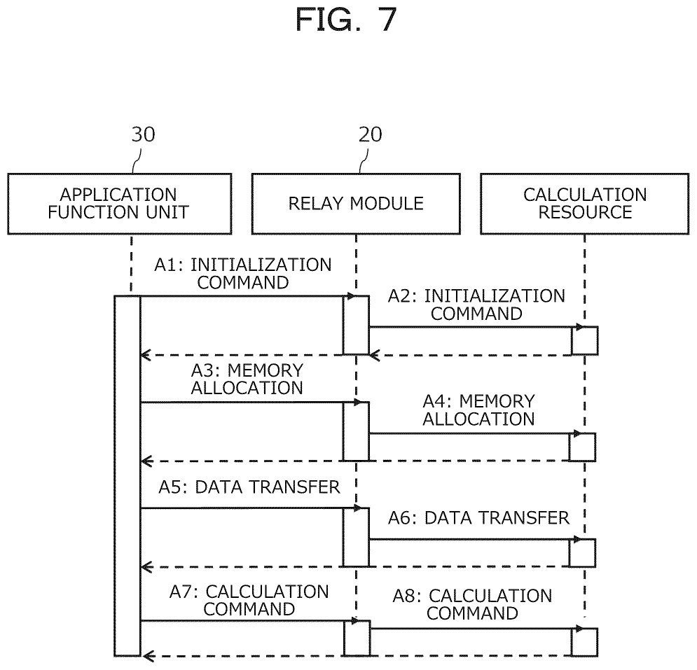

An overview of processing in the computer system 1 according to the embodiment configured as described above will be described with reference to the sequence diagram illustrated in FIG. 7.

FIG. 7 illustrates transmission and reception of commands and data between the application function unit 30, the relay module 20, and a calculation resource.

At the time of activation of the application function unit 30 in the server 10, the application function unit 30 issues an initialization command for the resource (see reference sign A1), and the relay module 20 receives the initialization command. The relay module 20 issues the initialization command to the calculation resource (see reference sign A2).

Next, the application function unit 30 issues a memory allocation command for the resource (see reference sign A3), and the relay module 20 receives the memory allocation command. The relay module 20 issues the memory allocation command to the calculation resource to be added (see reference sign A4).

The calculation resource is added to the server 10, and is in a state of being usable from the application function unit 30.

When the application function unit 30 performs data transfer (see reference sign A5), the relay module 20 receives the data. The relay module 20 transfers the data to the added resource (see reference sign A6).

After that, when the application function unit 30 issues a calculation command (see reference sign A7), the relay module 20 receives the calculation command. The relay module 20 transfers the calculation command to the added resource (see reference sign A8).

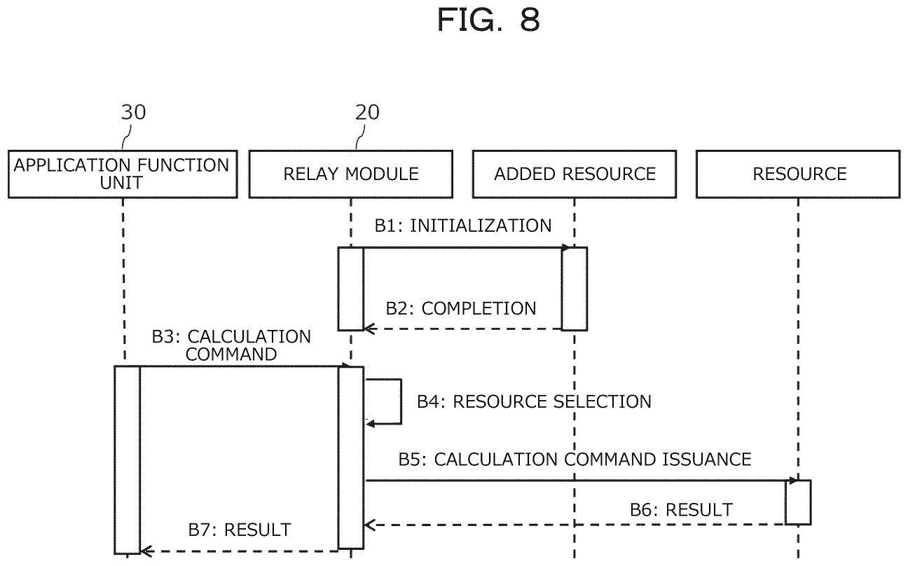

Next, processing at the time of resource addition in the computer system 1 according to the embodiment will be described with reference to a sequence diagram illustrated in FIG. 8.

FIG. 8 illustrates transmission and reception of commands and data between the application function unit 30, the relay module 20, an added resource, and a calculation resource other than the added resource.

As described above, for example, addition of a calculation resource may be performed in a case where a monitoring function (not illustrated) monitors a load state of a calculation resource in execution of an arithmetic operation, and the load state exceeds a threshold. Addition of a calculation resource may also be performed in a case where a user determines addition of a calculation resource and an input operation indicating that a calculation resource is to be added is performed.

The relay module 20 (resource control unit 21) issues an initialization command to the added resource and performs initialization processing (see reference sign B1). The added resource executes processing for initialization, and when the initialization is completed, notifies the relay module 20 of the completion (see reference sign B2).

After the initialization of the added resource is completed and the added resource is added to the server 10, the application function unit 30 issues a calculation command (see reference sign B3). The relay module 20 (resource control unit 21) selects a resource (selected resource) for processing the calculation command from among a plurality of resources added to the server 10 (see reference sign B4).

The relay module 20 (relay processing unit 22) issues, to the selected resource that has been selected, the calculation command issued from the application function unit 30 (see reference sign B5).

FIG. 8 illustrates an example in which a calculation command is issued to a resource that has been previously added to the server 10 as the selected resource.

The relay module 20 (relay processing unit 22) receives a calculation result from the resource that has processed the calculation command (see reference sign B6), and responds to the application function unit 30 with the calculation result (see reference sign B7).

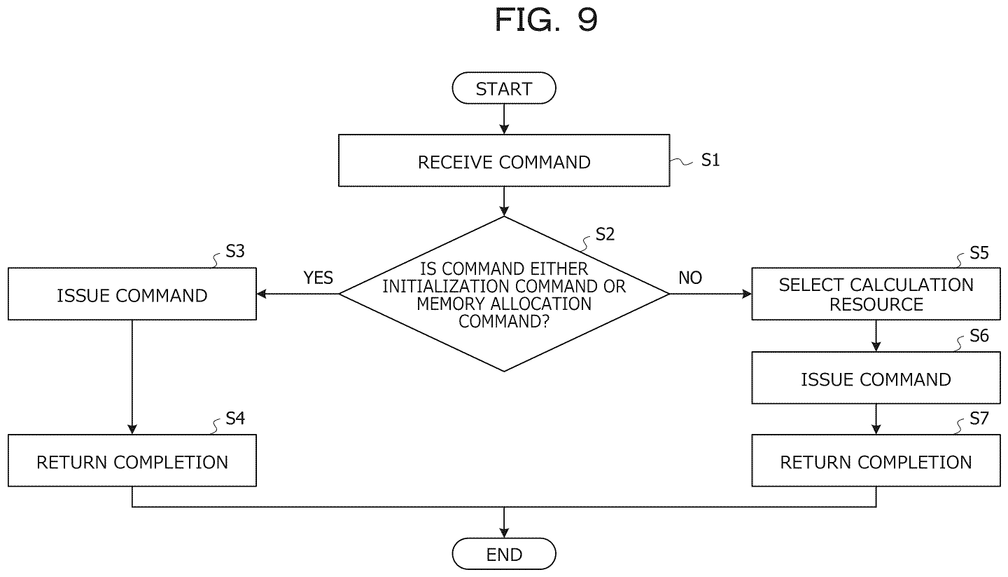

Next, processing of the relay module 20 at the time of command reception in the computer system 1 according to the embodiment will be described with reference to the flowchart illustrated in FIG. 9 (see steps S1 to S7).

In step S1, the relay module 20 (relay processing unit 22) receives a command issued from the application function unit 30.

In step S2, the relay module 20 checks whether the received command is either an initialization command or a memory allocation command. When the received command is either an initialization command or a memory allocation command as a result of the check (see YES route in step S2), the processing proceeds to step S3.

In step S3, the relay module 20 (resource control unit 21) issues a command similar to the received command to an added resource. For example, the relay module 20 issues either one of an initialization command and a memory allocation command to the added resource.

When a response to the issued command (completion) is received from the added resource, the relay module 20 responds to the application function unit 30 with the completion in step S4. After that, the processing ends.

When the received command is neither an initialization command nor a memory allocation command, for example, when the received command is a calculation command as a result of the check in step S2 (see NO route in step S2), the processing proceeds to step S5.

In step S5, the relay module 20 (resource control unit 21) selects a resource (selected resource) for processing the calculation command from among a plurality of resources added to the server 10.

In step S6, the relay module 20 (relay processing unit 22) issues (transfers) the calculation command to the selected resource that has been selected.

When a calculation result and completion for the issued calculation command is received from the resource, in step S7, the relay module 20 responds to the application function unit 30 with the calculation result and the completion. After that, the processing ends.

### (C) Effects

As described above, according to the computer system 1 as an example of the embodiment, addition and deletion of calculation resources may be achieved during execution of an application program in the server 10 without changing the code of the application program for causing the application function unit 30 to function. Accordingly, addition and deletion of resources may be dynamically performed. Execution of an application program may be speeded up.

For example, the relay module 20 may initialize a dynamically added resource by issuing an initialization command and a memory allocation command to the added resource, and may make a state in which the application function unit 30 may use the resource.

Even in a case where a plurality of resources is added by dynamic resource addition, the application function unit 30 may efficiently use the plurality of resources by the relay module 20 selecting a resource for processing a calculation command from among the plurality of resources.

### (D) Others

The disclosed technique is not limited to the above-described embodiment, and may be carried out while being modified in various ways within a scope not departing from the gist of the present embodiment.

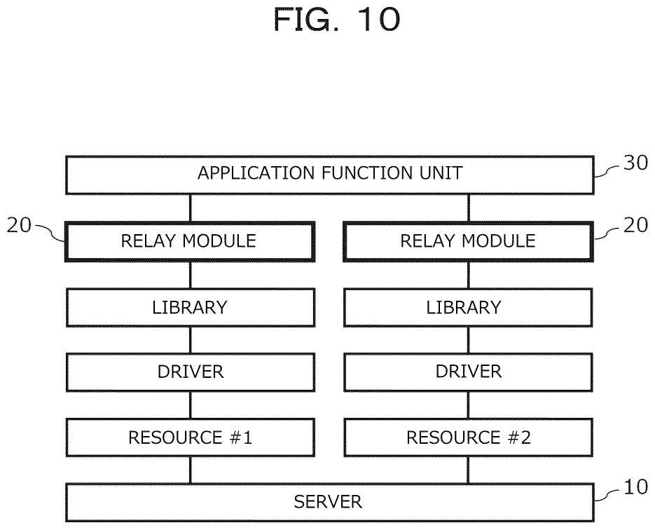

FIG. 10 is a diagram illustrating another example of a system configuration of the server 10 of the computer system 1 according to the embodiment.

In the example illustrated in FIG. 10, the relay module 20 is provided for each of resource #1 and resource #2. In this way, the relay module 20 may be provided for each type of resource.

Although GPU, FPGA, and accelerator are described as calculation resources in the above-described embodiment, a resource is not limited to these resources. A resource may be another IC such as an MPU, an APU, a DSP, or an ASIC.

Although addition of a resource is mainly described in the above-described embodiment, this is not the only case. The embodiment may be similarly applied to deletion of a resource.

The above-described disclosure enables a person skilled in the art to carry out and manufacture the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a processor, in an information processing apparatus to which a first physical resource among a plurality of physical resources of a resource pool is dynamically added, within a computer system having a composable infrastructure that includes the resource pool that includes the plurality of physical resources, to execute a process comprising:
initializing the first physical resource when the first physical resource is added;
issuing a calculation command to the first physical resource after initialization based on an arithmetic processing instruction issued from an application function that is realized by executing an application program by the processor; and
transmitting a result of arithmetic operation by the first physical resource to the application function.

2. The non-transitory computer-readable recording medium according to claim 1, the process further comprising:
in a case where two or more of the physical resources are added,
selecting a physical resource to which the calculation command is issued from among the two or more of the added physical resources.

3. A computer system comprising an information processing device and a resource pool including a plurality of physical resources, and having a composable infrastructure in which a first physical resource among the plurality of physical resources of the resource pool is dynamically added to the information processing device, the computer system further comprising:
an application function that causes the first physical resource to execute arithmetic processing; and
a relay that initializes the first physical resource when the first physical resource is added, issues a calculation command to the first physical resource after initialization based on an arithmetic processing instruction issued from the application function, and transmits a result of arithmetic operation by the first physical resource to the application function.

4. The computer system according to claim 3, wherein
the relay selects, in a case where two or more of the physical resources are added, a physical resource to which the calculation command is issued from among the two or more of the added physical resources.

5. The computer system according to claim 3, wherein
a processor of the information processing device functions as the application function by executing a first program, and
the processor functions as the relay by executing a second program different from the first program.

6. An information processing method performed by an information processing device, in a computer system that has a composable infrastructure that includes a resource pool including a plurality of physical resources, to which a first physical resource among the plurality of physical resources of the resource pool is dynamically added, the method comprising:
by an application function,
causing the first physical resource to execute arithmetic processing; and
by a relay,
initializing the first physical resource when the first physical resource is added,
issuing a calculation command to the first physical resource after initialization based on an arithmetic processing instruction issued from the application function, and
transmitting a result of arithmetic operation by the first physical resource to the application function.

7. The information processing method according to claim 6, wherein the method further comprising:
in a case where two or more of the physical resources is added, the relay selects a physical resource to which the calculation command is issued from among the two or more of the added physical resources.

8. The information processing method according to claim 6, wherein
a processor of the information processing device functions as the application function by executing a first program, and
the processor functions as the relay by executing a second program different from the first program.
